(19) United States
(12) Patent Application Publication
(10) Pub. No.: US 2010/0210433 A1
(43) Pub. Date: Aug. 19, 2010

(54) Tool Changing Device

(75) Inventor: Walter Grossmann, Baltmannsweiler (DE)

Correspondence Address: REINHART BOERNER VAN DEUREN P.C., 2215 PERRYGREEN WAY, ROCKFORD, IL, 61107, US

(73) Assignee: Index-Werke GmbH & Co. KG Hahn & Tessky, Esslingen (DE)

(21) Appl. No.: 12/579,834

(22) Filed: Oct. 15, 2009

Related U.S. Application Data
(63) Continuation of application No. PCT/EP2008/002919, filed on Apr. 12, 2008.

(30) Foreign Application Priority Data
Apr. 16, 2007 (DE) 10 2007 018710.8

(51) Int. Cl. B23Q 3/155

(52) U.S. Cl. 483/59; 483/66

(57) ABSTRACT

In order to improve a tool changing device for machine tools which have at least one tool carrier, comprising a tool magazine with a storage element which has a plurality of storage receptacles and can be moved for transferring the storage receptacles into at least one tool exchanging position, and with at least one first operating device, with which a tool can be transferred between the tool exchanging position and a tool changing position, defined by a tool receptacle of the at least one tool carrier located in a tool changing position, in such a manner that it is mounted efficiently on the machine tool it is suggested that the tool magazine and the first operating device be arranged on the machine tool so as to cooperate operatively and that the tool changing device be mounted on a machine frame of the machine tool as a unit essentially only with alignment of the tool changing device relative to the at least one in the tool changing position.

### CROSS-REFERENCE TO RELATED PATENT APPLICATIONS

This application is a continuation of international application number PCT/EP2008/002919 filed on Apr. 12, 2008.

The present disclosure relates to the subject matter disclosed in international application number PCT/EP2008/002919 of Apr. 12, 2008 and German application number 10 2007 018 710.8 of Apr. 16, 2007, which are incorporated herein by reference in their entirety and for all purposes.

### BACKGROUND OF THE INVENTION

The invention relates to a tool changing device for machine tools which have at least one tool carrier, comprising a tool magazine with a storage element which has a plurality of storage receptacles and can be moved for transferring the storage receptacles into at least one tool exchanging position and with a first operating device, with which transfer of a tool between the tool exchanging position and a tool changing position, defined by a tool receptacle of the at least one tool carrier located in a tool changing position, can be carried out.

Tool changing devices of this type are known from the state of the art. The problem with them is that they must be integrated into the concept of the machine tool and are, therefore, part of the machine tool itself and so a simple assembly and, for example, also a subsequent assembly are not possible.

The object underlying the invention is, therefore, to improve a tool changing device of the generic type in such a manner that it can be mounted efficiently on the machine tool.

### SUMMARY OF THE INVENTION

This object is accomplished in accordance with the invention, in a tool changing device of the type described at the outset, in that the tool magazine and the first operating device are arranged on the machine tool so as to cooperate operatively and that the tool changing device can be mounted on a machine frame of the machine tool as a unit essentially only with alignment of the tool changing device relative to the at least one tool carrier located in the tool changing position.

The advantage of this solution is to be seen in the fact that, with it, a unit which is operatively self-contained can be mounted as a whole on the machine frame and is, therefore, particularly easy to mount and, in particular, is also suitable for subsequent assembly.

With this solution it is particularly favorable when the tool magazine is arranged outside a working space of the machine tool since, as a result, the concept of the working space of the machine tool is not affected by the tool magazine or otherwise hindered in any way whatsoever.

Furthermore, it has proven to be favorable when the operating device has a guide, along which a tool gripping device of the operating device can be moved.

The tool gripping device may be moved into the working space in a particularly simple manner with an operating device of this type.

The object according to the invention may be accomplished in a particularly favorable manner from a constructional point of view in that the tool changing device has a device base which can be mounted on the machine frame of the machine tool and on which not only the tool magazine but also the operating device are held.

With respect to the arrangement of the guide of the operating device, no further details have been given in this regard. One favorable solution provides for the guide of the operating device to be provided on the device base so that during assembly of the device base an alignment of the guide of the operating device relative to the machine tool can also be carried out at the same time.

With respect to the alignment of the guide relative to the machine tool, no further details have so far been given. One particularly favorable solution provides for the guide to extend parallel to a plane of machining of the tool carrier which is defined by two predetermined axes of movement.

As a result of this alignment of the guide, it is possible in a particularly simple manner to insert the tools into the tool carrier.

The insertion of the tools may be realized, in particular, in a simple manner when the plane of machining extends approximately parallel to a central axis of the tool receptacle.

With respect to the alignment of the guide relative to a workpiece spindle provided on the machine tool, no further details have likewise been given.

It is particularly favorable when the guide extends approximately parallel to a spindle axis of a workpiece spindle of the machine tool. In this case, the tool may be supplied to the tool carrier in a particularly favorable manner; in particular, collisions with the workpiece spindle and the workpiece may be avoided.

Furthermore, it is particularly favorable when the guide extends approximately parallel to a central axis of the workpiece receptacle of the tool carrier located in a tool changing position so that the guide can also be used for the purpose of moving the tool in a direction of insertion.

In this respect, it is, in particular, favorable when the guide extends approximately parallel to a Z axis of the machine tool.

Since the integration of a tool changing device into a machine tool always represents a spatial problem, as well, the object specified at the outset can be accomplished in a particularly favorable manner when the tool magazine is arranged next to a machine bed member of the machine frame so that none of the devices and elements of the machine tool which are connected to the machine bed member hinder the provision and arrangement of the tool magazine.

Furthermore, the tool magazine can, in principle, be arranged on different sides of the machine bed member.

For example, it would be conceivable to arrange the tool magazine on an upper side of the machine bed member.

A solution which is favorable for the accessibility and arrangement of the tool magazine provides for the tool magazine to be arranged close to a side of the machine bed member which extends transversely to a Z axis.

The tool magazine itself can be designed in the most varied of ways.

For example, all conceivable designs of storage elements are conceivable.

A solution which is particularly favorable from a constructional point of view provides for the storage element to extend in a plane of storage which runs transversely, preferably at right angles, to a front side of the machine bed member.

The spatial arrangement of the storage element can be solved in a particularly favorable manner when the plane of storage extends at a distance from one side of the machine bed member.

With respect to the arrangement of the guide for the tool gripping device, no further details have so far been given.

For example, the guide could be arranged on one side of the plane of storage. A particularly favorable movement of the tool gripping device can, however, be realized when the guide passes through the plane of storage.

In this case, one expedient solution provides for the tool gripping device to be able to travel along the guide between a position on the magazine side and a position on the tool carrier side.

As a result, it is sufficient to move the tool gripping device along the guide in order to receive the tool, on the one hand, and, on the other hand, to insert it into the tool receptacle of the tool carrier.

One expedient solution provides in this respect for the tool gripping device to be located on one side of the plane of storage in the position on the magazine side and on the other side of the plane of storage in the position on the tool side so that the tool can be received in the area of the tool magazine in a simple manner and, on the other hand, can be inserted into the tool receptacle in a simple manner.

A particularly favorable, spatial arrangement provides for the tool gripping device to be located on a side of the plane of storage which faces away from the machine frame in the position on the magazine side.

With respect to the design of the tool gripping device itself, no further details have so far been given in conjunction with the preceding explanations concerning the individual embodiments. One advantageous solution, for example, provides for the first operating device to comprise a tool gripping device which is provided with a multiple gripping device, with which several tools can be gripped by several tool holding elements.

A tool gripping device designed in such a manner has the advantage that, as a result, tools can be inserted into the tool receptacle of the tool carrier with short tool changing times since it is possible, with the tool gripping device, to move the tool which is to be newly inserted with the one tool holding element, on the one hand, and at the same time, with another tool holding element, to remove the tool which is intended to be exchanged from the tool receptacle of the tool carrier.

In order to be able to realize this insertion and exchange of the tool in a simple manner, one expedient solution provides for the multiple gripping device to be held on a gripping device base so as to be movable.

A movement of this type could, in principle, be any optional form of movement. A solution, with which the multiple gripping device is mounted relative to a gripping device base of the tool gripping device so as to be pivotable about the pivot axis, is, however, simple to activate and simple to drive.

It is favorable, in particular, when it is provided in the case of such a multiple gripping device for one of the tool holding elements of the tool gripping device to be provided for receiving a tool from the tool carrier and one of the tool holding elements to be provided for the insertion of a tool into the tool carrier.

In principle, a drive for the tool gripping device can be provided as required.

A simple solution from a constructional point of view provides for a gripping device drive, with which the multiple gripping device can be moved between a tool receiving position and a tool delivery position, to be provided in the gripping device base, wherein, in this case, in the tool receiving position the tool is received from the tool receptacle of the tool carrier and in the tool transfer position the tool is inserted into and, therefore, delivered to the tool receptacle of the tool carrier.

It is preferably provided with such a solution for the multiple gripping device, in the position of the first operating device on the tool carrier side, to be associated with a tool holding element of the tool receptacle of the at least one tool carrier located in the tool changing position in order to remove the tool from it or insert the tool into it, depending on which procedure is intended to be carried out as a result.

In principle, it would be conceivable to have direct access to the tool magazine with the tool gripping device, in particular, the multiple gripping device and to remove the tools from the storage element or insert them into it.

Since, however, the storage element of the tool magazine can, as a rule, be rotated slowly and this slow movability should not have a delaying effect on the tool change, it is preferably provided for the operating device to have a transfer unit which is associated with the position of the multiple gripping device on the magazine side and with which a tool can be moved between the tool exchanging position and the tool transfer position for the multiple gripping device.

Such a transfer unit creates the possibility, during the times when the gripping device base and the tool gripping device are being moved into the working space and are being moved out of the working space as well as the tool exchanged, of removing the next following tool from the storage element of the tool magazine and keeping it ready in the tool transfer position for the multiple gripping device.

In this respect, it is provided, in particular, with the transfer unit for a tool to be removable from the storage element and be presentable to the multiple gripping device for take-up or a tool to be taken over by the multiple gripping device and insertable into the storage element, wherein these actions of the transfer unit are completely decoupled from the actions of the multiple gripping device and the gripping device base which are required in order to bring the tool from the tool transfer position into the tool changing position and vice versa. As a result, the procedure of changing the tool in the tool spindle can take place without any time factor caused by the storage element. It is this decoupling which contributes to the tool exchange with the storage element being configured more efficiently without any excessive resources being necessary on the part of the storage element in order to be able to move this quickly.

A movement of the tool may be realized particularly favorably when the tool can be moved between the tool exchanging position and the tool transfer position in one plane so that the geometric marginal conditions for the movement of the tool are very simple and, therefore, they can be met in a simple manner by a construction which operates quickly with respect to time.

With respect to the alignment of the tools in the storage element, no further details have so far been given. One advantageous solution, for example, provides for tool shafts of the tools to be aligned in the storage element approximately parallel to one another.

Furthermore, the storage element is advantageously designed such that the storage receptacles of the storage element which are provided for the tools can be moved in one plane so that the storage element can also be constructed and realized in a very simple manner.

In addition, it is advantageous when machine-side tool interfaces of the tools are aligned parallel to one another in the storage element.

Such a parallel alignment of the tool interface on the machine side allows a suitable, simple construction of the storage element.

Furthermore, it is advantageously provided for the machine-side tool interfaces of the tool to be aligned in the storage element parallel to the machine-side tool interface of the tool located in the tool changing position so that the transport or the movement of the tool by the operating device also requires no alteration in the alignment of the tool.

Preferably, it is likewise provided for the machine-side tool interface of the tool in the tool transfer position to be aligned parallel to the machine-side tool interface of the tool in the tool changing position in order not to have to alter the alignment of the tools in the operating device in this respect, as well.

One favorable embodiment of the tool changing device according to the invention provides in this respect for the machine-side tool interface of the tool in the tool carrier which is located in the tool changing position to be aligned parallel to the machine-side tool interface of the tool held in the multiple gripping device.

In order to be able to insert the tool into the tool receptacle of the tool carrier which is located in a tool changing position in a simple manner, it is provided for the multiple gripping device to be movable in a direction of insertion relative to the tool receptacle of the tool carrier which is located in a tool changing position. This can be brought about either by moving the gripping device base along the guide or by means of an axis of movement between an arm of the tool gripping device and the gripping device base.

It is favorable for the realization of the multiple gripping device when tool holding elements of the multiple gripping device can be moved in a plane extending transversely to the direction of insertion in order to be able to use the tool holding element at the tool receptacle in a simple manner, which is required in order to remove a tool seated in this tool receptacle or insert another tool.

With respect to the preceding embodiments of the tool changing device according to the invention, the focus was merely on the fact that the first operating device is present.

One expedient solution provides for the tool changing device to have a second operating device, with which transfer of a tool between a second tool exchanging position of the tool magazine and a tool receptacle of a second tool carrier, which is located in a tool changing position, can be carried out.

The advantage of this solution is to be seen in the fact that it manages with one tool magazine but is in a position to change the tools of two tool carriers quickly and efficiently with two operating devices.

In the case of the solution according to the invention with the second operating device, it is preferably provided for this to be conceived in the same way with regard to all the additional designs and have the same features as the individual embodiments of the first tool changing device described above.

In addition, the invention relates to a machine tool, comprising a machine frame, a workpiece receptacle arranged on the machine frame and at least one tool carrier which is arranged on the machine frame and with which workpieces held in the workpiece receptacle can be machined and which can be positioned in a tool changing position.

The object specified at the outset of designing a machine tool of this type with a tool changing device which can easily be mounted is also applicable for this machine tool.

This object is accomplished in that the machine tool specified above has a tool changing device which is designed in accordance with one or several of the features described above.

One advantageous embodiment of such a machine tool provides for the machine tool to have two tool carriers, each of which can be brought into a tool changing position, and for the machine tool to be provided with a tool changing device according to one or several of the features described above.

In this respect, it is expediently provided for the two tool carriers, in their tool changing positions, to be arranged so as to be approximately parallel to one another with central axes of their tool receptacles in order to be able to insert the tools into these tool carriers in as simple and efficient a manner as possible.

Furthermore, it is favorable with this solution when the two tool carriers, in their tool exchanging positions, are arranged so as to be at a distance from one another in a direction transverse to the central axes of the tool receptacles.

In this respect, the central axes of the tool receptacles of the two tool carriers are preferably arranged in the tool changing positions such that they are located approximately in one plane.

Such a plane is, in addition, preferably aligned such that it extends approximately parallel to a front surface of the machine bed member.

Additional features and advantages of the invention are the subject matter of the following description as well as the drawings illustrating several embodiments.

### BRIEF DESCRIPTION OF THE DRAWINGS

FIG. 1 shows a first perspective illustration of a first embodiment of a machine tool according to the invention with a tool changing device according to the invention, wherein the tool is in a tool changing position as a result of the tool changing device;

FIG. 2 shows a second perspective illustration of the first embodiment according to FIG. 1;

FIG. 3 shows a third perspective illustration of the first embodiment of the machine tool according to the invention with a tool changing device according to the invention with a tool located in a tool transfer position;

FIG. 4 shows a fourth perspective illustration of the first embodiment of the machine tool according to the invention with a tool changing device according to the invention with a tool located in a tool transfer position;

FIG. 5 shows a perspective illustration of a gripping device base of the first embodiment in a tool changing position;

FIG. 6 shows an additional perspective illustration of the gripping device base during the pivoting of the gripping device arm;

FIG. 7 shows a perspective illustration of a transfer unit in a tool transfer position;

FIG. 8 shows a section similar to line 8-8 in FIG. 7 but in a tool changing position;

FIG. 9 shows a perspective illustration similar to FIG. 1 of a second embodiment of a machine tool according to the invention with a tool changing device according to the invention;

FIG. 10 shows a perspective illustration similar to FIG. 2 of the second embodiment of the machine tool according to the invention with a tool changing device according to the invention;

FIG. 11 shows a perspective illustration similar to FIG. 3 of the second embodiment of the machine tool according to the invention with a tool changing device according to the invention;

FIG. 12 shows a perspective illustration similar to FIG. 4 of the second embodiment of the machine tool according to the invention with a tool changing device according to the invention;

FIG. 13 shows a perspective illustration similar to FIG. 3 of a third embodiment of a machine tool according to the invention with a tool changing device according to the invention;

FIG. 14 shows a perspective illustration similar to FIG. 2 of the third embodiment of the machine tool according to the invention with a tool changing device according to the invention;

FIG. 15 shows a perspective illustration similar to FIG. 3 of the third embodiment of a machine tool according to the invention with a tool changing device according to the invention;

FIG. 16 shows a perspective illustration similar to FIG. 1 of a fourth embodiment of a machine tool according to the invention with a tool changing device according to the invention;

FIG. 17 shows a perspective illustration similar to FIG. 2 of the fourth embodiment of the machine tool according to the invention with a tool changing device according to the invention;

FIG. 18 shows a perspective illustration similar to FIG. 3 of the fourth embodiment of the machine tool according to the invention with a tool changing device according to the invention and a counterspindle located in a workpiece transfer position and

FIG. 19 shows a perspective illustration similar to FIG. 13 of the fourth embodiment of the machine tool according to the invention with a tool changing device according to the invention and a counterspindle moved into a machining position.

### DETAILED DESCRIPTION OF THE INVENTION

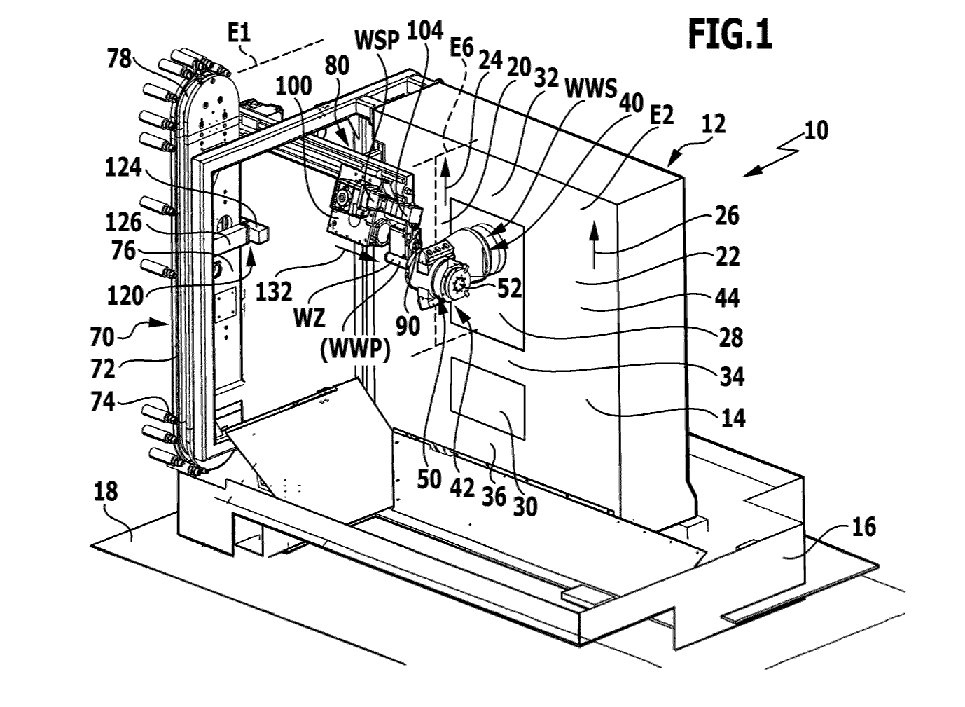

A first embodiment of a machine tool 10 illustrated in FIG. 1 comprises a machine frame 12 with a machine bed member 14 as well as with a base 16 which supports the machine bed member 14 and with which the machine frame 12 is arranged on a support surface 18.

The machine bed member 14 comprises, for example, two columns 20 and 22 which rise above the base and extend approximately parallel to one another and the longitudinal axes 24, 26 of which extend approximately parallel and transversely, preferably at right angles, to the support surface 18.

Furthermore, passages 28, 30 are provided between the columns 20 and 22 and are delimited by crossbars 32, 34, 36 extending between the columns 20, 22.

As a result, the machine bed member 14 encloses the passages 28 and 30 in a yoke-like manner and, therefore, forms an altogether stable and rigid structure.

A first tool carrier designated as a whole as 40 is held, for example, on the machine bed member 14 and projects into a working space 42 which is located in front of a front side 44 of the machine bed member 14, wherein the tool carrier 40 is seated for this purpose on a guide base 46 which preferably passes through the passage 28.

Such a machine frame 12 is described, for example, in detail in the German patent applications DE 10 2006 026 183 and DE 10 2006 026 184.

The first tool carrier 40 is provided with a first tool spindle 50, into the tool receptacle 52 of which a tool WZ can be inserted.

Such a tool WZ can be driven by the tool spindle 50 for rotation about a tool spindle axis 54 and serves the purpose of machining either workpieces arranged stationarily on the machine frame 12 or also workpieces held, for example, in workpiece spindles which are not illustrated in the drawings for the first embodiment.

Since the necessity exists of being able to machine a workpiece with a plurality of different tools WZ, the machine tool 10 is provided with a tool changing device which is designated as a whole as 60 and can be mounted on the machine frame 12, in particular, on the machine bed member 14.

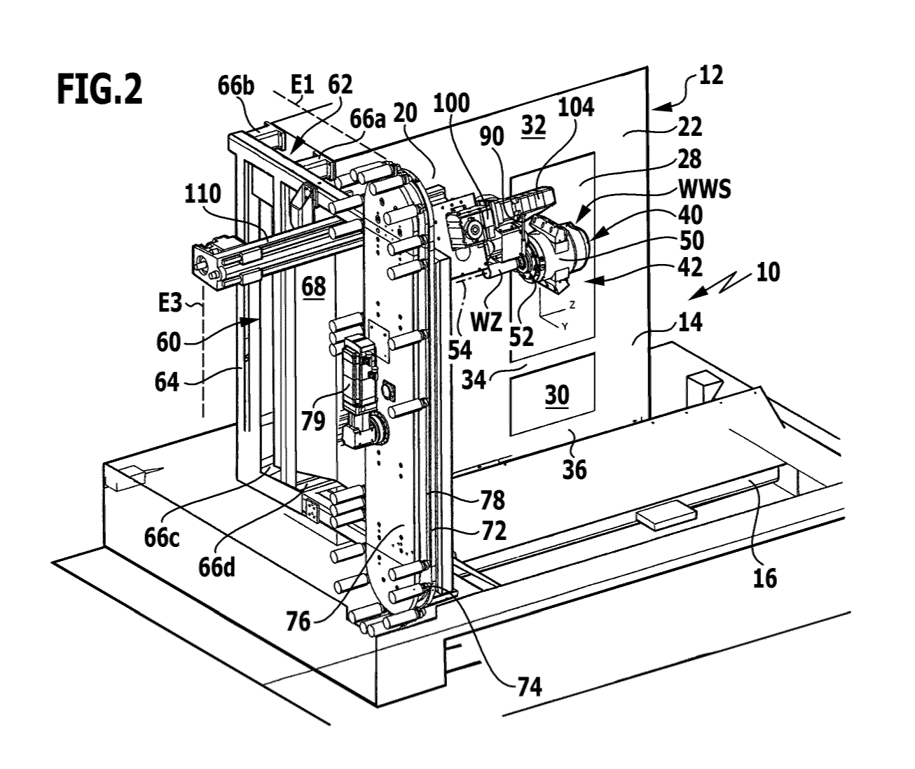

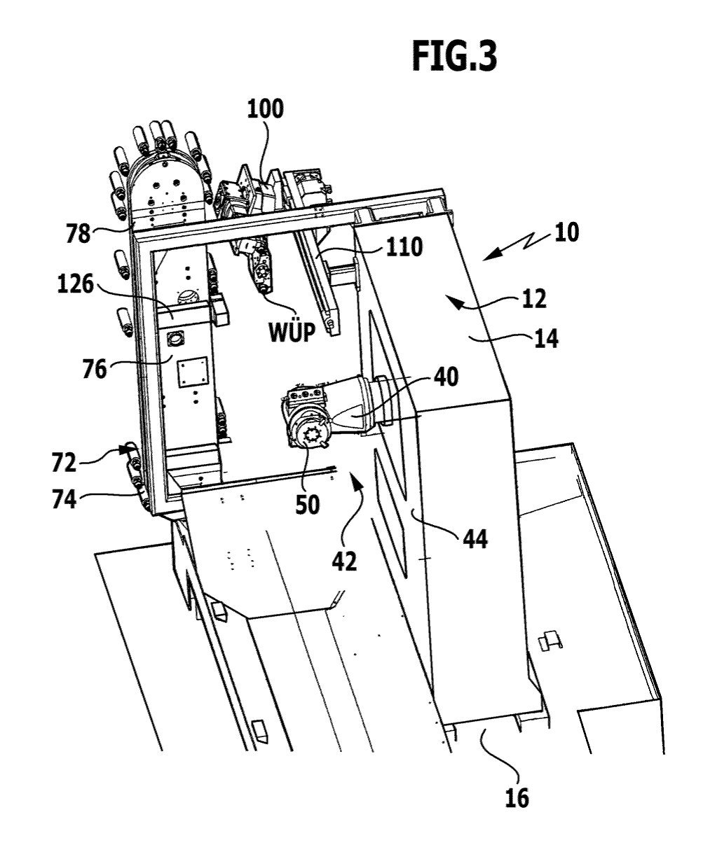

The tool changing device 60 has, as illustrated, in particular, in FIGS. 2 and 3, a device base which is designated as a whole as 62 and comprises a frame 64 which can be mounted on an outer side 68 of the machine bed member 14 by way of supporting arms 66a to 66d, wherein the outer side 68 preferably extends transversely to the front side 44 and approximately parallel to the longitudinal directions 24, 26 and, therefore, approximately transverse to the support surface 18.

A tool magazine designated as a whole as 70 as well as at least one first operating device designated as a whole as 80 are held on the device base 62.

The tool magazine 70 is, for its part, designed as a chain magazine and comprises a circulating storage chain 72, on which storage receptacles 74 are provided, wherein tools WZ can be inserted into the storage receptacles 74.

The storage chain 72 is, for its part, guided on a chain support 76 which is provided with a circular path 78, on which the storage chain 72 is held so as to circulate and is guided such that the storage receptacles move in a plane of storage E1, wherein the plane of storage E1 extends transversely to the front side 44 and at a distance from the outer side 68.

The storage chain 72 can be driven in a circulating manner by a drive unit 79 so that each of the storage receptacles 74 can be moved such that the tool WZ can be brought into a tool exchanging position WAP, from which the tool WZ can be taken by the first operating device 80 and inserted into the tool receptacle 52 of the tool spindle 50 which is located in a tool changing position WWS, wherein the tool WZ, for this purpose, can be brought into the tool changing position WWP illustrated in FIG. 1.

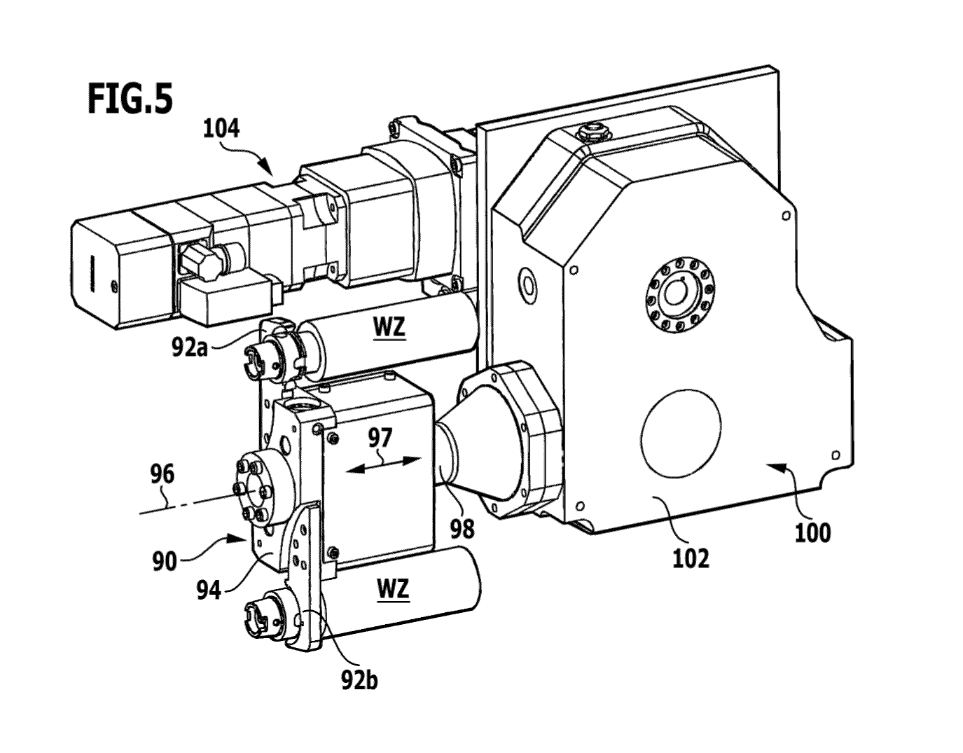

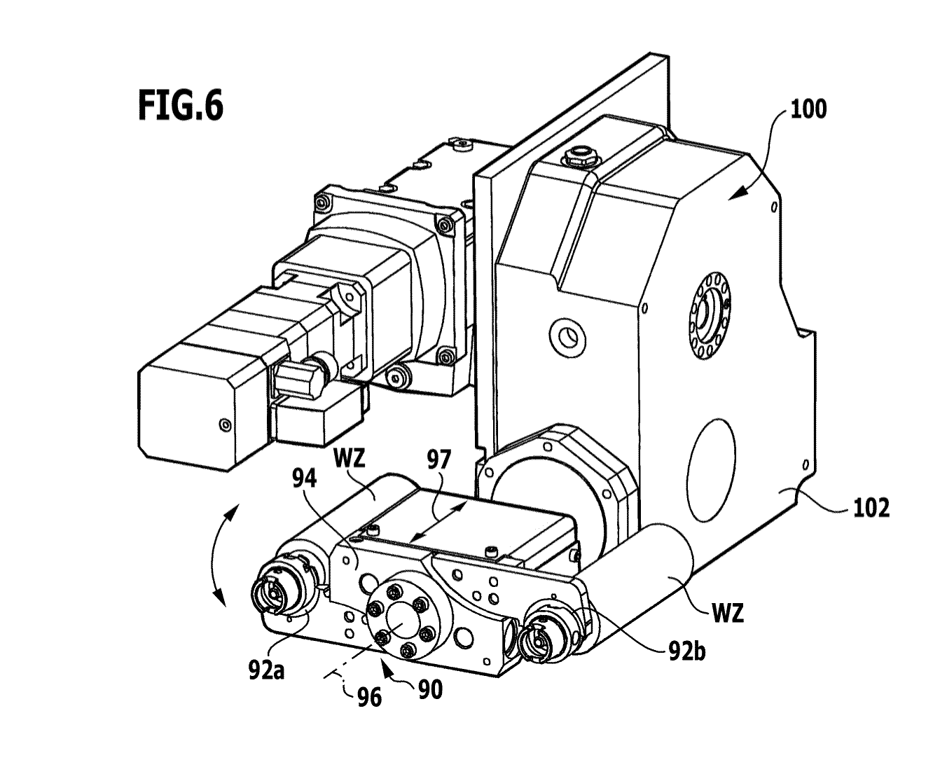

For this purpose, the operating device comprises, as illustrated, in particular, in FIGS. 1 to 4 as well as FIGS. 5 and 6, a tool gripping device 90 which is designed as a multiple gripping device and has several, for example, two tool holding elements 92a and 92b which are arranged, for example, on a gripping device arm 94 which, for its part, is held on a gripping device base designated as a whole as 100 so as to be pivotable about a pivot axis 96.

In this respect, the gripping device arm 94 is preferably held on a shaft 98 which, for its part, is mounted in the gripping device base 100 so as to be pivotable about the pivot axis 96 and, in addition, displaceable in a direction 97 parallel to the pivot axis 96.

The gripping device base 100 comprises a housing 102, into which the shaft 98 is guided and in which the shaft 98 is rotatable about the pivot axis 96 and displaceable parallel to it.

Furthermore, a drive 104 is associated with the housing 102 and this serves the purpose of pivoting the shaft 98 together with the gripping device arm 94 about the pivot axis 96 and also displacing them in the direction thereof in order to move the gripping arm 94 with the tool holding elements 92a and 92b for the purpose of exchanging the tool WZ from the tool spindle 50 of the tool carrier 40 located in a tool changing position WWS.

In this respect, the drive 104 preferably drives a rocker arm drive device which is provided in the housing 102 and not illustrated in the drawings and which carries out the pivoting movement of the gripping device arm 94 about the pivot axis 96 and the movement thereof in the direction 97 parallel to the pivot axis 96 overlying one another.

The entire gripping device base 100 is, for its part, guided on a longitudinal guide 110, wherein the longitudinal guide 110 is arranged on the device base 62, preferably on the frame 64, and predetermines a direction of guidance 112, along which the gripping device base 100 can be moved so that the gripping device base 100 can be moved between a position WSP on the tool carrier side and a position MSP on the magazine side.

In this respect, the gripping device base 100 is located in the position WSP on the tool carrier side, as illustrated in FIGS. 1, 2 and FIG. 5, such that the gripping device 90 removes the tool WZ from the tool spindle 50 with, for example, the free tool holding element 92b, turns the gripping device arm 94 through approximately 180°, then positions the tool WZ held in the tool holding element 92a in the tool changing position WWP and then inserts this tool WZ into the tool receptacle 52 of the tool spindle 50.

The longitudinal guide 100 passes through the planes of storage E1 and, therefore, the gripping device base 100 in the position WSP on the tool carrier side is located on one side of the plane of storage E1 whereas the gripping device base 100 in the position MSP on the magazine side is located on the oppositely located side of the plane of storage E1.

In the position MSP on the magazine side, the gripping device base 100 is located such that the tool gripping device 90 can interact with a transfer unit 120, wherein the gripping device arm 94 is not turned in relation to the tool changing position WWP (FIG. 6) and so the transfer unit (120) is, in the tool exchanging position WAP, in a position to remove a tool WZ from the storage receptacle 74 located in the corresponding tool exchanging position WAP and to transfer it to the tool gripping device 90 in a tool transfer position WUP.

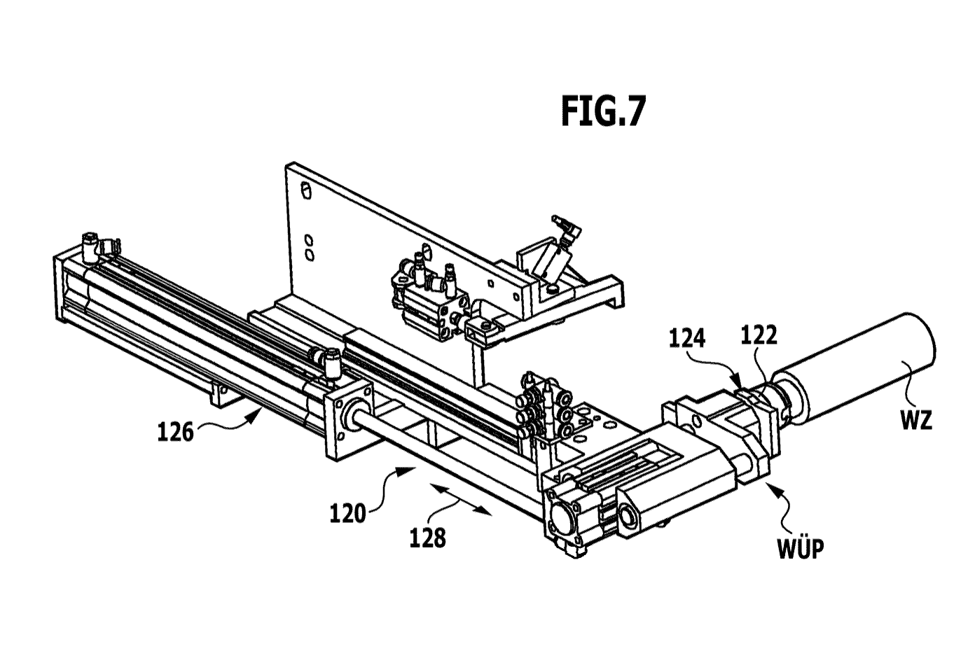

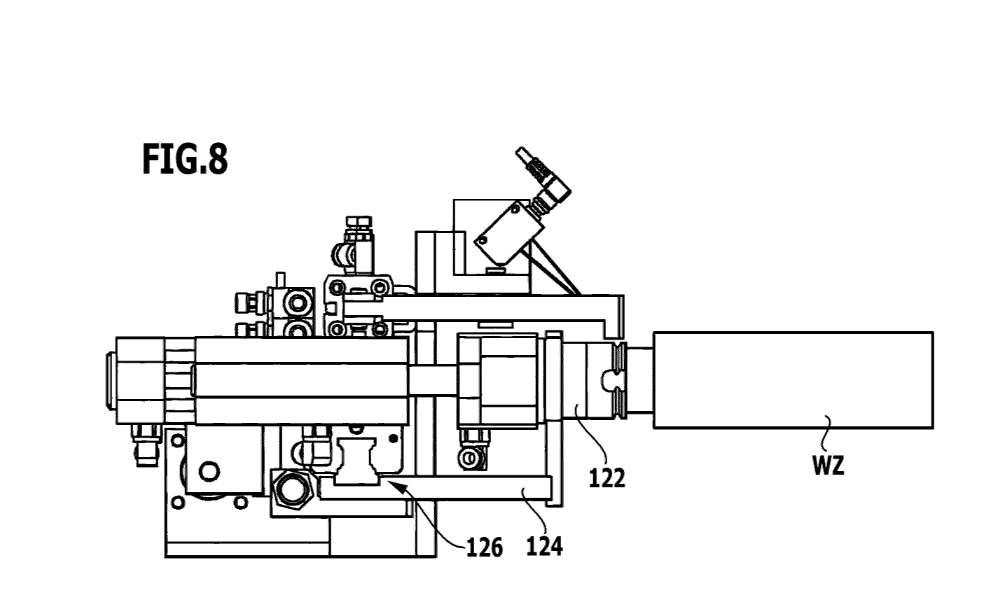

For this purpose, the transfer unit 120, as illustrated in FIGS. 7 and 8, is preferably designed such that it has a first transfer gripping device 124 which accommodates the respective tool WZ at a tool interface 122 on the machine side and is guided on a guide 126, which forms, for example, a linear guide for the transfer gripping device 124, so as to be displaceable linearly in a direction of extension 128 and, therefore, can be moved from the position, in which the tool WZ is taken over in the tool exchanging position WAP, to such an extent in the direction of the direction of extension 128 that the tool WZ is located in the tool transfer position WUP, in which it can be taken over by the tool gripping device 90.

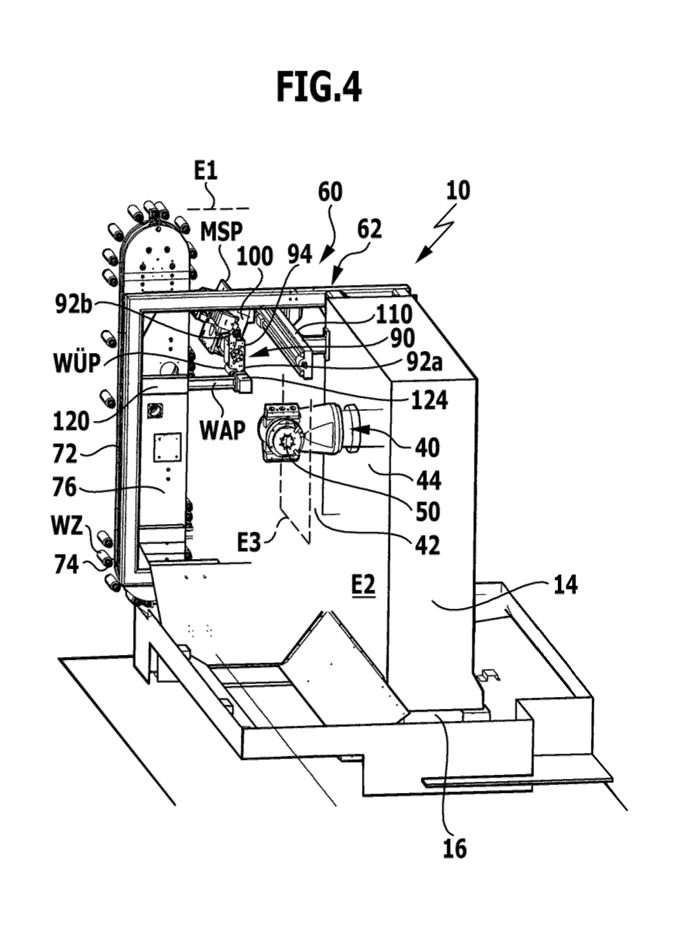

It is, therefore, possible, as a result of the transfer unit 120, to insert the tool WZ transferred to the transfer gripping device 124 in the tool exchanging position WAP (FIG. 3) into a storage receptacle 74 of the storage chain 72 and, following movement of the storage chain 72, to remove an additional tool WZ, namely the next one to be inserted, for example, from another storage receptacle 74 of the storage chain 72 and move it from the tool exchanging position WAP (FIG. 3) into the tool transfer position WUP (FIG. 4) during the time the gripping device base 100 is traveling from the position MSP on the magazine side into the position WSP on the tool carrier side and during the change of tool in the tool spindle 50.

In the tool transfer position WUP, the tool will then be removed from the transfer gripping device 124 (FIG. 4) by means of the tool gripping device 90, which is designed as a multiple gripping device, with the free tool holding element 92a so that a tool which is to be newly inserted is arranged in the tool holding element 92a and the tool WZ from the tool holding element 92b will be inserted into the transfer gripping device 124 so that the tool holding element 92b is free. A change of the tool in the tool spindle 50 can then be carried out with the tool gripping device 90 by moving the gripping device base 100 from the position MSP on the magazine side into the position WSP on the tool carrier side and by pivoting the gripping device arm through 180°, wherein, in this case, the tool WZ present in the tool receptacle 52 of the tool spindle 50 will be removed from it first of all with the free tool holding element 92b (FIG. 5) and then the tool WZ, which is held in the tool holding element 92a, will be inserted into the tool receptacle 52 of the tool spindle 50 after the gripping device arm 94 has been pivoted about the pivot axis 96 through approximately 180°. This change is brought about as a result of movement of the tool gripping device 90 in the direction 97 of the pivot axis 96.

In order the utilize the spatial conditions for the tool changing device 60 according to the invention in an optimum manner, it is preferably provided for the tool magazine 70 to be arranged outside the working space 42 and for the storage chain 72 to be located in the plane of storage E1 which is defined by the storage receptacles 74 and extends such that it does not intersect the machine bed member 14.

The plane of storage E1 preferably extends transversely, in particular, at right angle to a plane E2 which is determined by the front side 44 of the machine bed member 14.

As a result of the fact that all the storage receptacles 74 are located in the plane of storage E1 and grip the tools WZ in the area outside the tool interface 122 on the machine side, the tools WZ are aligned with their tool shafts 130 transversely, preferably at right angles, to the plane of storage E1 and parallel to one another.

The tools WZ can likewise be moved in the plane of storage E1 during any movement from the tool exchanging position WAP into the tool transfer position WUP, wherein the tool shafts 130 still extend transversely, preferably at right angles, to the plane of storage E1.

The alignment of the tool shafts 130 relative to the plane of storage E1 is retained even during transfer of the tools WZ in the tool transfer position WUP into the tool gripping device 90, wherein in the tool gripping device 90, as well, the tools WZ with their tool shafts 130 retain the alignment of the shaft 130 during their movement into the tool changing position WWP so that the tools WZ in the tool changing position WWP are also aligned with their shafts 130 with the same alignment as in exchanging position WAP and the tool transfer position WUP and will be inserted into the tool receptacle 52 of the tool spindle 50 in this alignment which means that the tool receptacle 52 and, in particular, the tool spindle axis 54 must also be aligned such that they are aligned transversely, preferably at right angles, to the plane of storage E1 and, therefore, approximately parallel to the respective tool shaft 130.

The machine-side tool interface 122 of the tools WZ held in the storage receptacles 74 of the storage chain 72 extends with its axis of symmetry 123 transversely, for example, at right angles to the plane of storage E1 and remains in this alignment even when the tools WZ are gripped by the transfer gripping device 124 in the area of the tool interface 122 on the machine side and are brought from the tool exchanging position WAP into the tool transfer position WUP and are gripped by the tool gripping device 90.

The tools WZ can be moved with the tool gripping device 90 in a plane E3 extending parallel to a plane E2 defined by the front side 44 of the machine bed member 14, namely such that the axis of symmetry 123 is located in the plane E3 or at least approximately parallel to this plane E3.

In this alignment, the tools WZ can be brought from the tool transfer position WUP into the tool changing position WWP, in which insertion of the tools WZ takes place in that the respective tool interface 122 on the machine side is aligned in its axis of symmetry 123 coaxially to the tool spindle axis 54 and is inserted into the tool receptacle 52 in a direction of insertion 132 extending parallel to the tool spindle axis 54.

For this purpose, the respective tool interface 122 on the machine side can be moved transversely to the plane E3 by way of pivoting of the tool gripping device 90 about the pivot axis 96 and can also be moved in the direction of insertion 132 by way of displacement of the tool gripping device 90 in the direction of the pivot axis 96, wherein the alignment of the axis of symmetry 123 of the tools WZ in the tool magazine 70 is still essentially parallel.

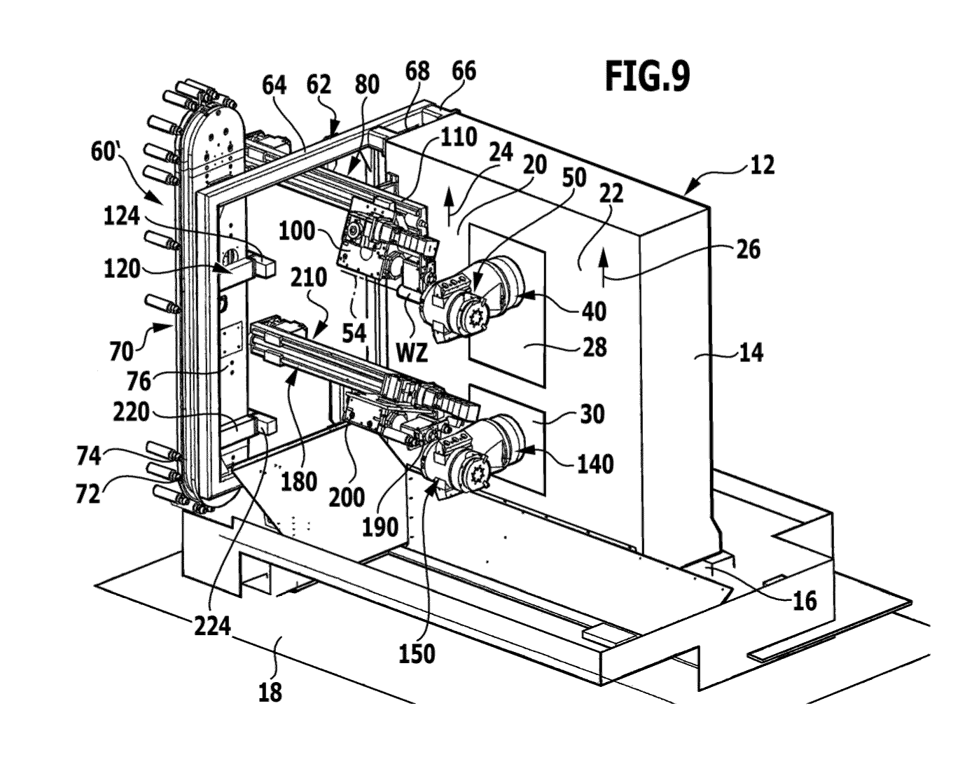

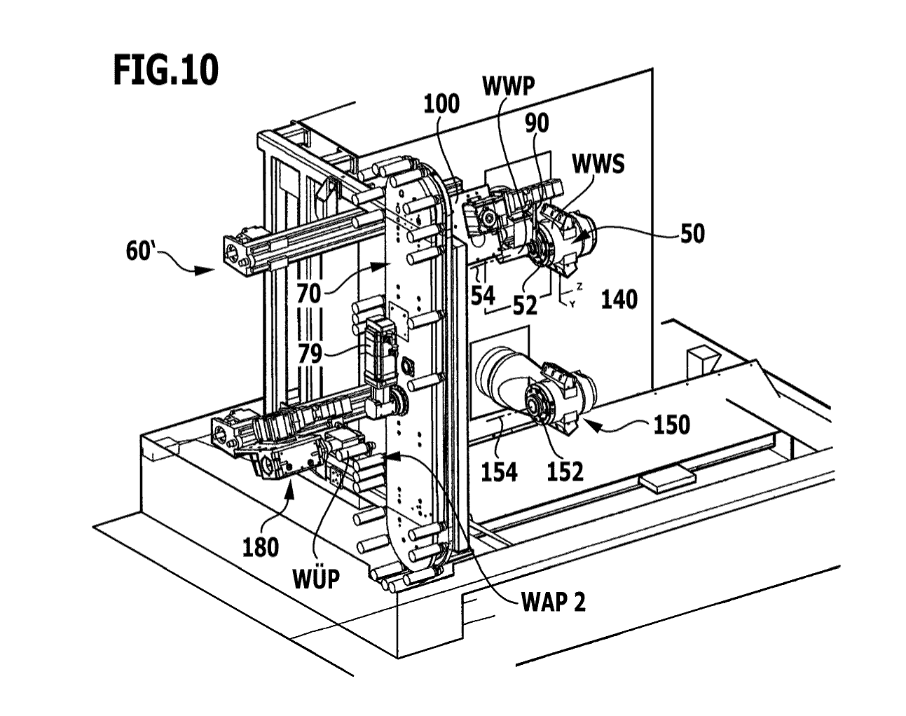

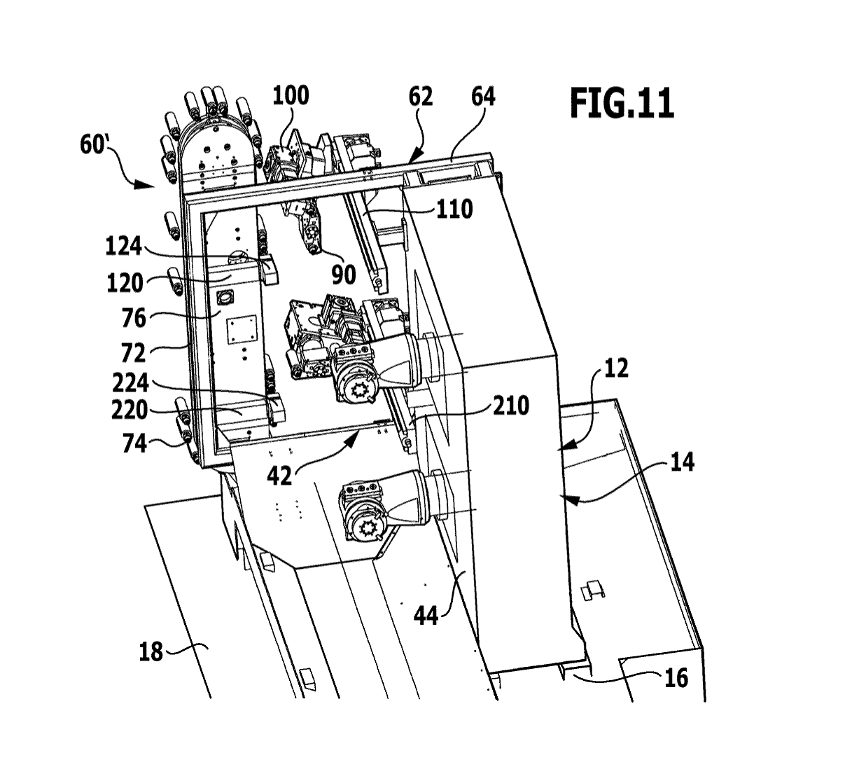

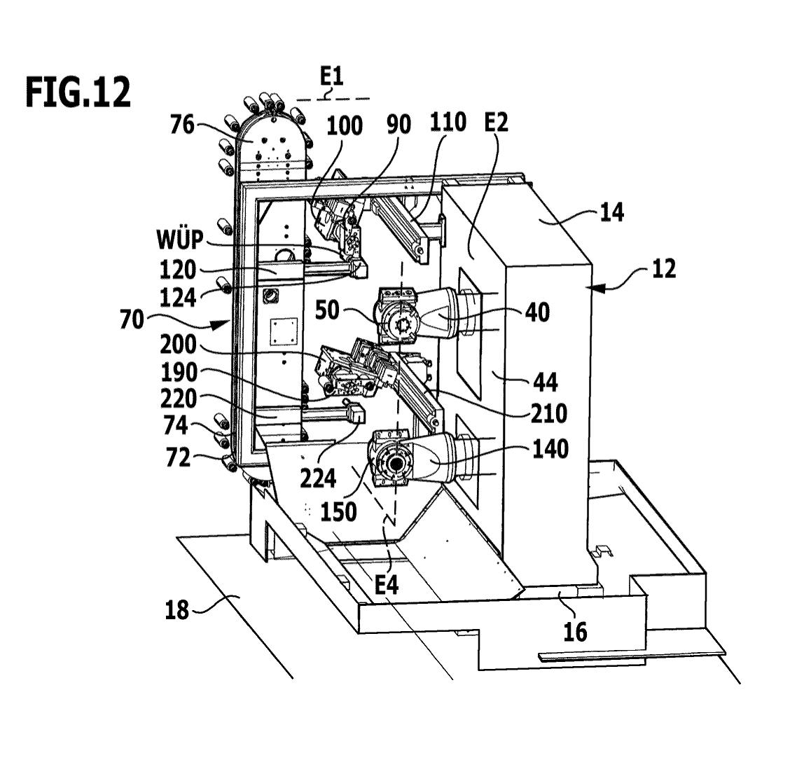

In a second embodiment of a tool changing device according to the invention, illustrated in FIGS. 9 to 12, a second tool carrier 140, which is provided with a second tool spindle 150, is provided in addition to the first tool carrier 40.

In this case, the tool changing device 60′ has not only the first operating device 80 but also a second operating device 180 which is constructed in the same way as the first operating device and serves the purpose of removing a tool from the tool magazine 70, namely in a second tool exchanging position WAP, and inserting it into the tool receptacle 152 of the second tool spindle 150.

In this respect, the second operating device 180 comprises, in the same way as the first operating device 80, a tool gripping device 190 which is designed as a double gripping device and is arranged on a gripping device base 200 which is designed and constructed in the same way as the first gripping device base 100 and is guided on a longitudinal guide 210.

Furthermore, the second operating device 180 also comprises the second transfer unit 220, the transfer gripping device 224 of which operates in the same way as the transfer gripping device 124 of the first transfer unit 120.

As a result, the exchanging of the tool WZ in the second tool spindle 150 can be carried out in the same way as that described in conjunction with the first embodiment and so in this respect reference can be made in full to the explanations concerning the first embodiment.

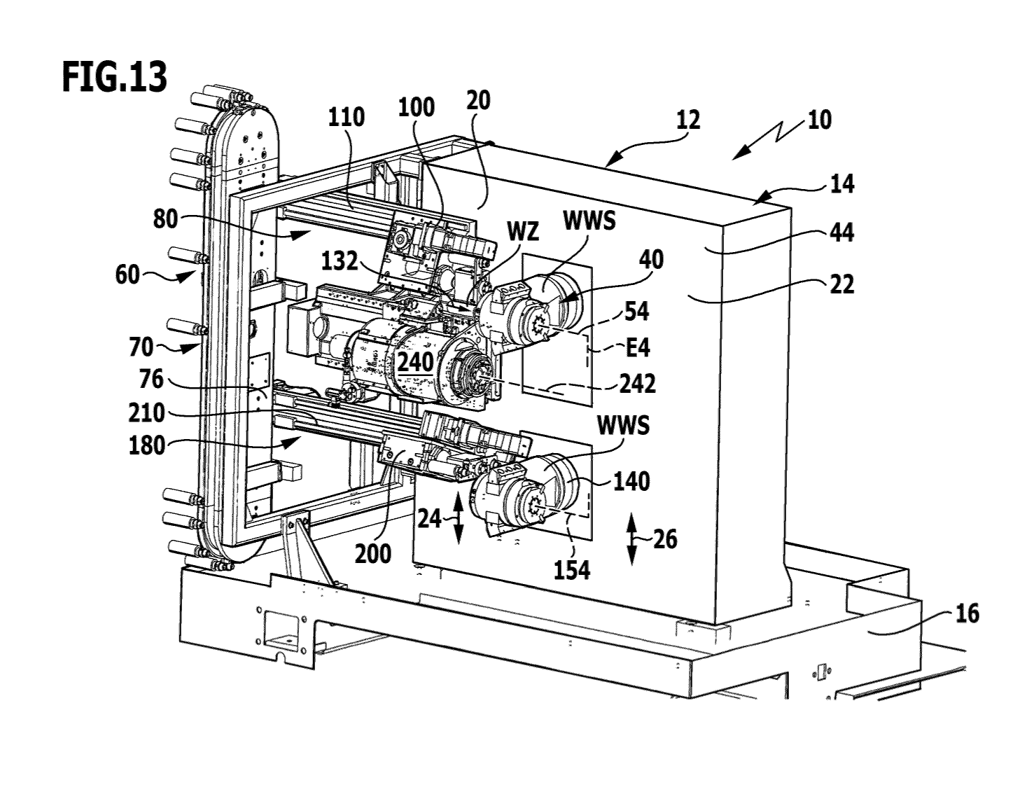

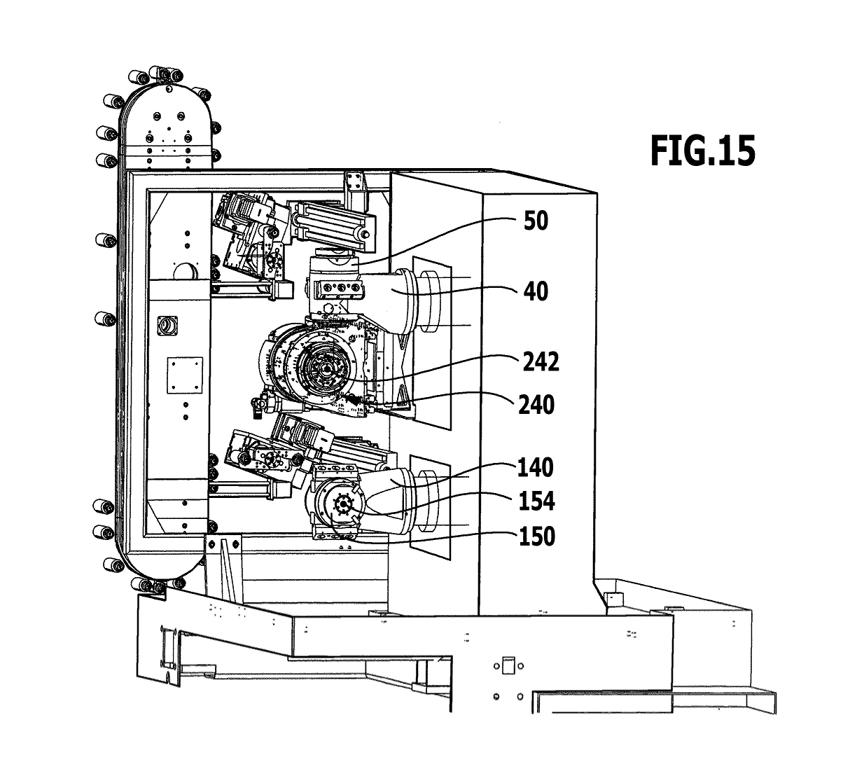

In a third embodiment, illustrated in FIGS. 13 to 15 and proceeding on the basis of the second embodiment, a workpiece spindle 240 is provided, in addition, for receiving a workpiece which can be machined, for example, by the tool WZ of the first tool spindle 50 or a tool WZ of the second tool spindle 150 insofar as a relative movement between the workpiece spindle 240 and the tool carriers 140 or 40 is possible to such an extent that the respective tools WZ reach the workpiece in the workpiece spindle 240.

The workpiece spindle 240 is preferably arranged and aligned such that its workpiece spindle axis 242 extends approximately parallel to the plane E2 and preferably at right angles to the plane E1. Furthermore, the workpiece spindle 240 is arranged such that it is located between the longitudinal guides 110 and 210 of the operating devices 80 and 180 so that the gripping device bases 100 and 200, respectively, can also move laterally past the workpiece spindle 240 without them colliding with the workpiece spindle 240.

This means that, in this embodiment, the tool carriers 40 and 140 are positioned in their respective tool changing positions WWS such that the tool spindle axes 54 and 154, respectively, extend on either side at a distance from the workpiece spindle 240.

In this respect, the tool spindle axes 54 and 154 are preferably located, when the tool carriers 40, 140 are located in the tool changing position WWS, in a common plane E4 which, for its part, extends parallel to the workpiece spindle axis 242 and, therefore, also parallel to the Z direction during machining of the workpiece.

Furthermore, the plane E4 lies preferably parallel to the plane E3 and, therefore, also preferably approximately parallel to a front side 44 of the machine bed member 14.

As a result, it is possible, when the tool carriers 40 and 140 are located in a tool changing position WWS, to insert a respective tool WZ into the corresponding tool receptacle 52 and 152, respectively, without collisions with the workpiece spindle 240 and the workpiece held in it being able to occur.

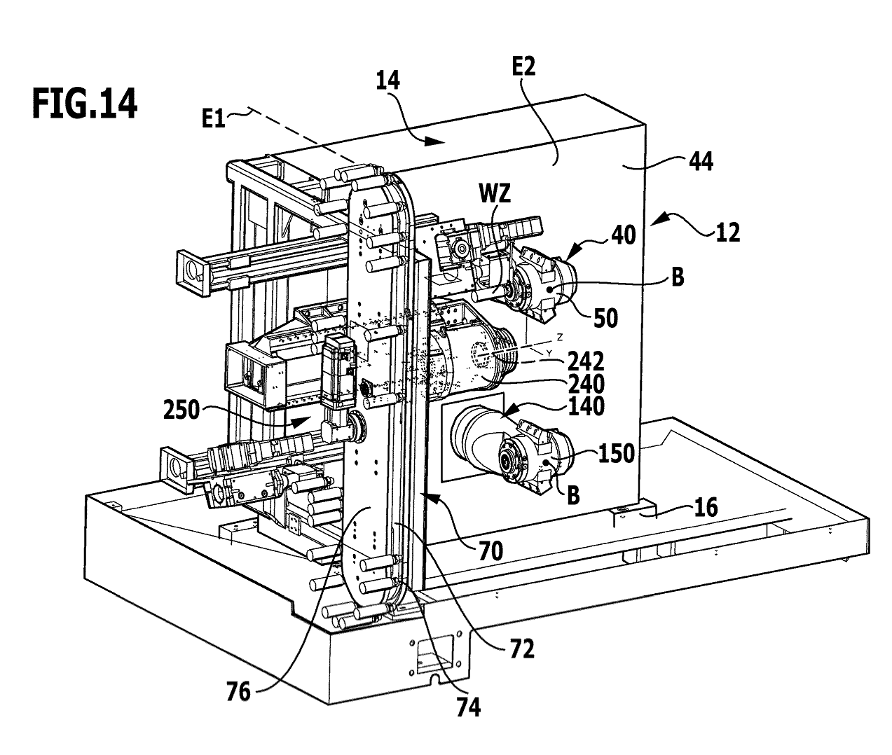

Furthermore, it is also provided in the third embodiment according to FIGS. 13 to 14 for the workpiece spindle 240 to be displaceable by means of a slide system 250 in the direction of the workpiece spindle axis 242 and, therefore, in Z direction relative to the machine bed member 14 so that for the machining of a workpiece held in the workpiece spindle 240, for example, a relative movement in the Z direction takes place as a result of movement of the workpiece spindle 240 in the Z direction by means of the slide system 250 and, on the other hand, the tool carriers 40 and 140 can, for their part, be moved in the X direction and the Y direction relative to the machine bed member 14 and, in addition, can be rotated about a so-called B axis which extends parallel to the Y axis.

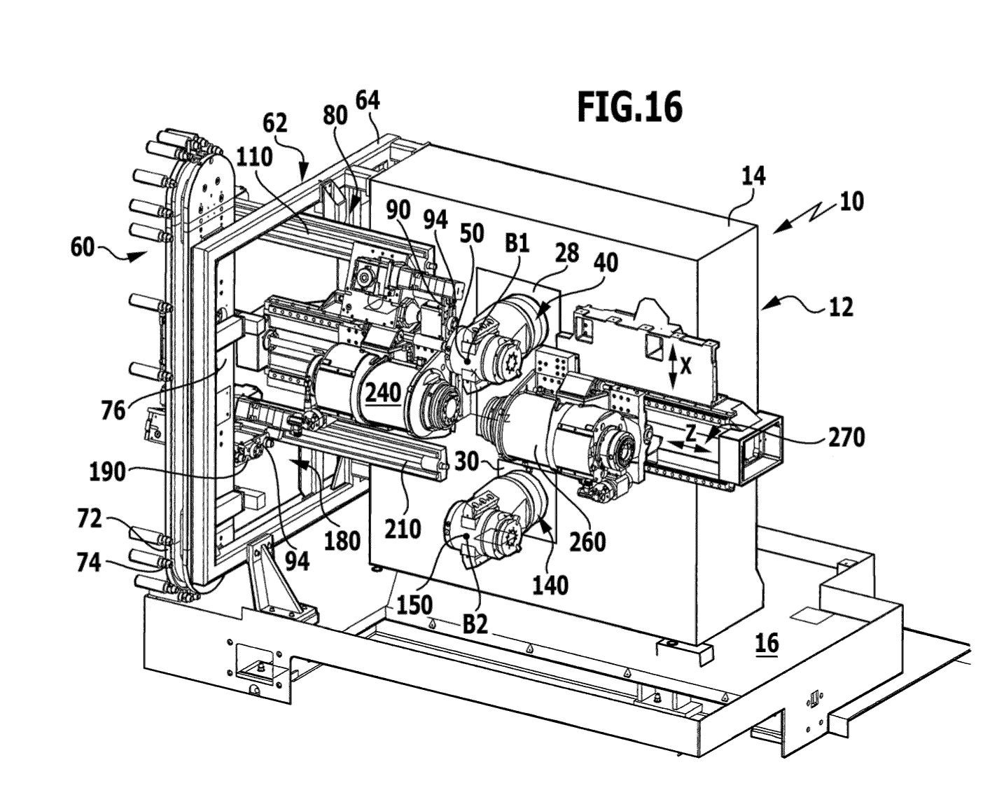

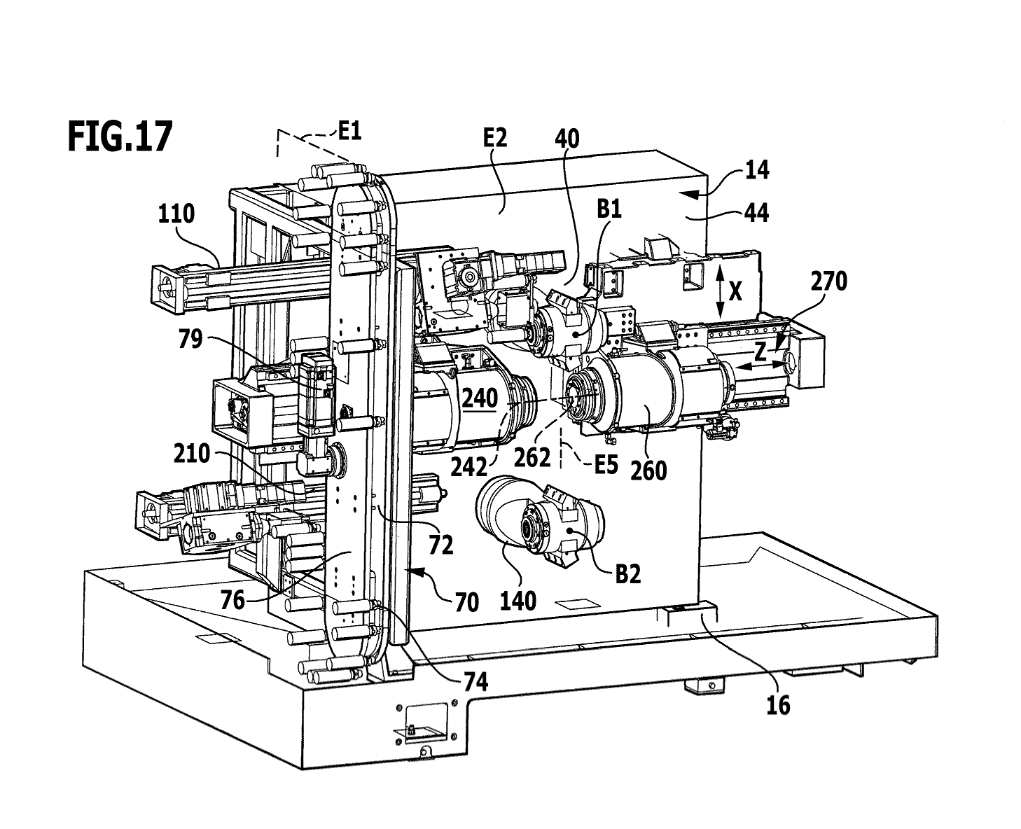

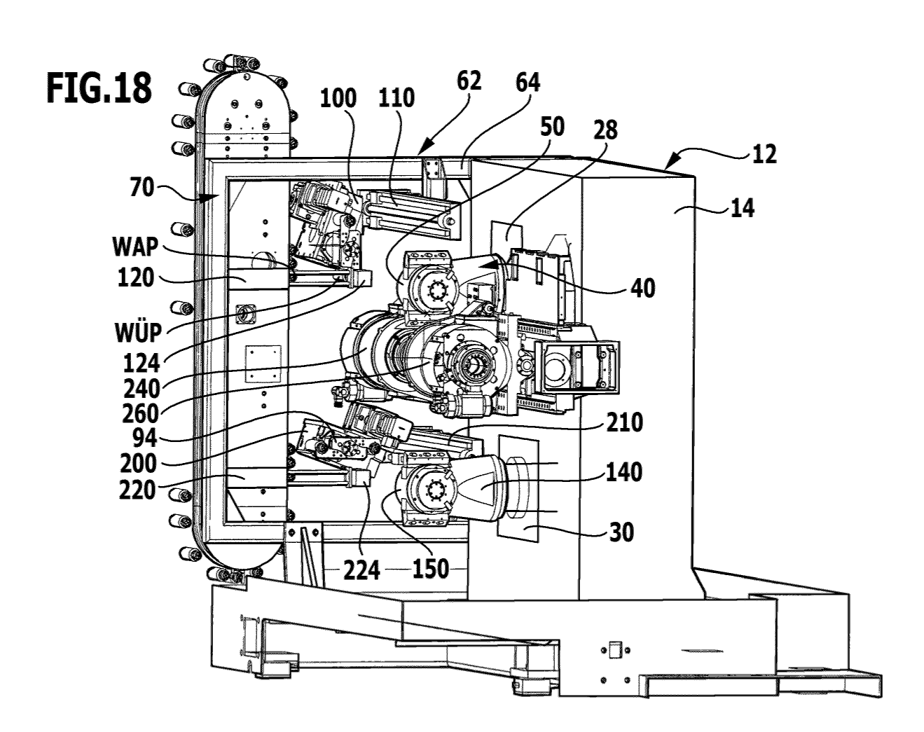

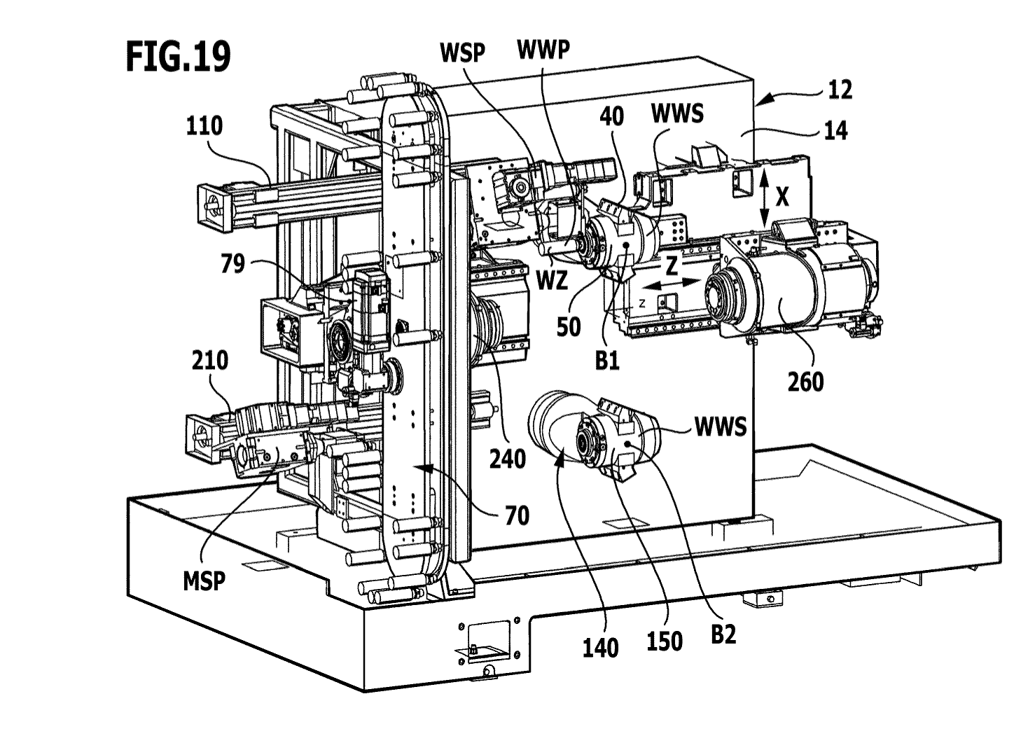

In a fourth embodiment, illustrated in FIGS. 16 to 19, those elements which are identical to those of the embodiments described above are provided with the same reference numerals and so, with respect to the description thereof, reference is also made in full to the explanations concerning these embodiments.

In contrast to the third embodiment, the fourth embodiment according to FIGS. 16 to 19 represents an extended embodiment which has, in addition to the workpiece spindle 240, a second workpiece spindle 260 which, for its part, can be moved relative to the machine bed member 14 in a so-called X direction in that a slide system bearing the workpiece spindle 260 and guiding it in Z direction is guided on the machine bed member 14 for displacement in X direction, likewise as a slide system.

As a result, the second workpiece spindle 260 can be moved by the slide system 270 in the Z direction and can be moved together with the slide system 270 in the X direction relative to the machine bed member 14 so that the second workpiece spindle 260 can, on the one hand, be aligned coaxially to the first workpiece spindle 240 but, on the other hand, for example, can be moved in the direction of the second tool carrier 140 in order for this workpiece spindle 260 to be arranged, for example, with its workpiece spindle axis 262 coaxially or non-coaxially relative to the second tool carrier 140, wherein the second tool carrier 140 can in this case, for example, be arranged stationarily, i.e., it is not displaceable in X direction relative to the machine bed member 14 but is merely rotatable about its B axis B2 and can, where applicable, be moved in Y direction.

On the other hand, the first tool carrier 40 can still be rotated in its B1 axis and, for its part, be displaced preferably at least in X direction, in particular also in Y direction, relative to the machine bed member.

In the fourth embodiment as well as in the third embodiment, the first plane E1 or plane of storage preferably extends at right angles to the plane E2 and, therefore, also preferably at right angles to the workpiece spindle axes 242 and 262.

Furthermore, the workpiece spindle axes 242 and 262 are preferably located in a plane E5 which extends, in particular, parallel to the plane E3 and, therefore, also parallel to the plane E4 and can be arranged such that it coincides with the plane E4.

Finally, the tool holding elements 92 are, in the fourth embodiment, located in a plane E6 which is parallel to the plane E2 and can be moved in this plane.

1-41. (canceled)

42. Tool changing device for machine tools having at least one tool carrier, comprising a tool magazine with a storage element having a plurality of storage receptacles, said storage element being movable for transferring the storage receptacles into at least one tool exchanging position, and with at least one first operating device for carrying out transfer of a tool between the tool exchanging position and a tool changing position defined by a tool receptacle of the at least one tool carrier located in a tool changing position, the tool magazine and the first operating device being arranged on the machine tool so as to cooperate operatively and the tool changing device being adapted to be mounted on a machine frame of the machine tool as a unit essentially only with alignment of the tool changing device relative to the at least one tool carrier located in the tool changing position.

43. Tool changing device as defined in claim 42, wherein the tool magazine is arranged outside a working space of the machine tool.

44. Tool changing device as defined in claim 42, wherein the operating device has a guide, a tool gripping device of the operating device being movable along said guide.

45. Tool changing device for machine tools having at least one tool carrier, comprising a tool magazine with a storage element having a plurality of storage receptacles, said storage element being movable for transferring the storage receptacles into at least one tool exchanging position, and with at least one first operating device for carrying out transfer of a tool between the tool exchanging position and a tool changing position defined by a tool receptacle of the at least one tool carrier located in a tool changing position, the tool changing device having a device base adapted to be mounted on the machine frame of the machine tool, and both the tool magazine and the operating device being held on said device base.

46. Tool changing device as defined in claim 45, wherein the operating device has a guide, a tool gripping device of the operating device being movable along said guide, and he guide of the operating device is provided on the device base.

47. Tool changing device as defined in claim 46, wherein the guide extends parallel to a plane of machining of the tool carrier defined by two predetermined axes of movement.

48. Tool changing device as defined in claim 47, wherein the plane of machining extends approximately parallel to a central axis of the tool receptacle.

49. Tool changing device as defined in claim 46, wherein the guide extends approximately parallel to a spindle axis of a workpiece spindle of the machine tool.

50. Tool changing device as defined in claim 46, wherein the guide extends approximately parallel to a central axis of the tool receptacle of the tool carrier located in a tool changing position.

51. Tool changing device as defined in claim 46, wherein the guide extends approximately parallel to a Z axis of the machine tool.

52. Tool changing device for machine tools having at least one tool carrier, comprising a tool magazine with a storage element having a plurality of storage receptacles, said storage element being movable for transferring the storage receptacles into at least one tool exchanging position, the tool magazine being arranged next to a machine bed member of the machine frame, and with at least one first operating device for carrying out transfer of a tool between the tool exchanging position and a tool changing position defined by a tool receptacle of the at least one tool carrier located in a tool changing position.

53. Tool changing device as defined in claim 52, wherein the tool magazine is arranged close to a side of the machine bed member extending transversely to a Z axis.

54. Tool changing device as defined in claim 52, wherein the storage element extends in a plane of storage running transversely to a front side of the machine bed member.

55. Tool changing device as defined in claim 54, wherein the plane of storage extends at a distance from one side of the machine bed member.

56. Tool changing device as defined in claim 54, wherein the guide passes through the plane of storage.

57. Tool changing device as defined in claim 42, wherein the operating device comprises a tool gripping device which is adapted to travel along a guide between a position on the magazine side and a position on the tool carrier side.

58. Tool changing device as defined in claim 57, wherein the tool gripping device is located on one side of the plane of storage in the position on the magazine side and on the other side of the plane of storage in the position on the tool side.

59. Tool changing device as defined in claim 57, wherein the tool gripping device is located on a side of the plane of storage facing away from the machine frame in the position on the magazine side.

60. Tool changing device as defined in claim 42, wherein the first operating device comprises a tool gripping device provided with a multiple gripping device, several tools being adapted to be gripped by several tool holding elements with said multiple gripping device.

61. Tool changing device as defined in claim 60, wherein the multiple gripping device is mounted on a gripping device base so as to be movable.

62. Tool changing device as defined in claim 60, wherein the multiple gripping device is mounted relative to a gripping device base of the tool gripping device so as to be pivotable about a pivot axis.

63. Tool changing device as defined in claim 61, wherein a gripping device drive is provided in the gripping device base, the multiple gripping device being movable between a tool receiving position and a tool delivery position with said drive and wherein in a tool changing position the multiple gripping device is associated with a tool holding element of the tool receptacle of the at least one tool carrier located in a tool changing position.

64. Tool changing device as defined in claim 60, wherein the operating device has a transfer unit associated with the position of the multiple gripping device on the magazine side, a tool being movable between the tool exchanging position and a tool transfer position for the multiple gripping device with said transfer unit.

65. Tool changing device as defined in claim 42, wherein the machine-side tool interface of the tool located in a tool exchanging position is aligned in the storage element parallel to the machine-side tool interface of the tool located in a tool changing position.

66. Tool changing device as defined in claim 42, wherein the machine-side tool interface of the tool in the tool transfer position is aligned parallel to the machine-side tool interface of the tool in the tool changing position.

67. Tool changing device for machine tools having at least one tool carrier, comprising a tool magazine with a storage element having a plurality of storage receptacles, said storage element being movable for transferring the storage receptacles into at least one tool exchanging position, and with at least one first operating device for carrying out transfer of a tool between the tool exchanging position and a tool changing position defined by a tool receptacle of the at least one tool carrier located in a tool changing position, the tool changing device having a second operating device for carrying out transfer of a tool between a second tool exchanging position of the tool magazine and a tool changing position.

68. Machine tool comprising a machine frame, a workpiece receptacle arranged on the machine frame and at least one tool carrier arranged on the machine frame, workpieces held in the workpiece receptacle being machinable with said tool carrier, and said tool carrier being positionable in a tool changing position, wherein the machine tool has a tool changing device designed in accordance with claim 42.

69. Machine tool as defined in claim 68, wherein the machine tool has two tool carriers, each of said tool carriers being adapted to be brought into a tool changing position and wherein the machine tool is designed with a tool changing device as defined in claim 42.

70. Machine tool as defined in claim 69, wherein in their tool changing positions the two tool carriers are arranged so as to be approximately parallel to one another with central axes of their tool receptacles.

71. Machine tool as defined in claim 70, wherein in their tool changing positions the two tool carriers are arranged so as to be at a distance from one another in a direction transverse to the central axes of the tool receptacles.

72. Machine tool as defined in claim 69, wherein in the tool exchanging positions the central axes of the tool receptacles of the two tool carriers are located approximately in one plane.
